(19) United States
(12) Patent Application Publication
(10) Pub. No.: US 2003/0048723 A1
(43) Pub. Date: Mar. 13, 2003

(54) Optical pickup and optical disk recording/playback unit

(76) Inventor: Mikio Yamamuro, Ome-shi (JP)

Correspondence Address: PILLSBURY WINTHROP, LLP, P.O. BOX 10500, MCLEAN, VA, 22102, US

(21) Appl. No.: 10/234,715

(22) Filed: Sep. 5, 2002

(30) Foreign Application Priority Data
Sep. 12, 2001 (JP) 2001-275944
Dec. 25, 2001 (JP) 2001-392691

(51) Int. Cl. G11B 7/00

(52) U.S. Cl. 369/53.37; 369/59.17

(57) ABSTRACT

An optical pickup includes a laser output section to emit a laser beam onto a recording medium, a photodetector to receive the light reflected by the recording medium, an amplifier to output a signal corresponding to the strength of the reflected light output from the photodetector, and a control circuit which can receive a signal which changes for data recording and playback, and suppresses the amplifier gain during recording.

### CROSS-REFERENCE TO RELATED APPLICATIONS

This application is based upon and claims the benefit of priority from the prior Japanese Patent Applications No. 2001-275944, filed Sep. 12, 2001; and No. 2001-392691 filed Dec. 25, 2001, the entire contents of both of which are incorporated herein by reference.

### BACKGROUND OF THE INVENTION

1. Field of the Invention

The present invention relates to an optical pickup which records information on a recordable optical disk by radiating a light beam onto the disk and reads out recorded information from the disk, and an optical disk recording/playback unit equipped with said optical pickup.

2. Description of the Related Art

One prior art concerning the present invention is disclosed by Jpn. Pat. Appln. KOKAI Publication No. 2000-182241 (Jun. 30, 2000).

Disclosed are an optical disk unit which records signals on an optical disk according to the DVD-RAM (Digital Versatile Disc-Random Access Memory) standard, and a head amplifier mountable in said optical disk unit.

An optical disk is widely used as a recording medium capable of recording a large amount of information. When recording signals on the optical disk, a large amount of optical energy must be concentrated on the recording surface. It is thus necessary to activate a laser element which emits a light beam at its rated output or by the power equivalent to the rating.

When recording information on the optical disk, a servo signal is necessary to control the position of the light beam emitted onto the recording surface of the optical disk. In many cases, the servo signal is obtained from the light beam reflected by the optical disk, or reflected light created from the large-energy light beam for recording. Thus, the dynamic range of the playback signal becomes extremely large.

This demands use of large dynamic range amplifier to obtain the servo signal. Otherwise, the amplifier will be saturated, and the servo data included in the playback signal will be lost. Without servo data, light beam position control is impossible and exact information recording is disabled.

### BRIEF SUMMARY OF THE INVENTION

A general object of the present invention is to provide an optical pickup capable of extracting a servo signal for light beam position control from a large dynamic range playback signal obtained from reflected light created from a large-energy light beam for recording, and an optical disk recording/playback unit.

It is a more specific object of the invention to provide an optical pickup comprising: a laser output section to emit a laser beam onto a recording medium; a photodetector to receive reflected light from the recording medium; an amplifier to output a signal corresponding to the strength of the reflected light output from the photodetector; a current bias circuit to output a bias current; a switch circuit which is provided between the current bias circuit and the input terminal of the amplifier, and controls the bias current from the bias circuit; and a control circuit to control the switch circuit depending on data recording state and data playback state.

It is another object of the invention to provide an optical disk recording/playback unit comprising: a disk motor to turn a recording medium at a predetermined speed; a laser output section to emit a laser beam to the recording medium; a photodetector to receive reflected light from the recording medium; an amplifier to output a signal corresponding to the strength of the reflected light output from the photodetector; a current bias circuit to output a bias current; a switch circuit which is provided between the current bias circuit and the input terminal of the amplifier, and controls the bias current received from the bias circuit; and a control circuit to control the switch circuit depending on data recording state and data playback state.

It is still another object of the invention to provide an optical pickup for use in an optical disk unit capable of recording a signal on an optical disk, and for recording the signal by emitting a light beam to the optical disk, comprising: a light source to generate the light beam to be emitted to the optical disk; a photodetector which detects a light beam reflected by the recording surface of the optical disk, and outputs a playback signal containing servo data to generate a servo signal for controlling the light beam position on the recording surface; and an amplifier which passes a frequency component of the playback signal obtained from the photodetector lower than a predetermined cutoff frequency when recording a signal.

It is a further object of the invention to provide an optical disk recording/playback unit comprising: an optical pickup including a light source to generate a light beam to be emitted to an optical disk; a photodetector which detects a light beam reflected by the recording surface of the optical disk, and outputs a playback signal containing servo data to generate a servo signal for controlling the light beam position on the recording surface; and an amplifier which passes a frequency component of the playback signal obtained from the photodetector lower than a predetermined cutoff frequency when recording a signal; and a disk motor to turn a recording medium at a predetermined speed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram explaining an example of an optical disk recording/playback unit to which an embodiment of the present invention is applicable;

FIG. 2 is a circuit diagram explaining an example of a preamplifier applicable to the optical disk recording/playback unit shown in FIG. 1;

FIG. 3 is a graphical representation of the output signal waveforms of the preamplifier shown in FIG. 2;

FIG. 4 shows a waveform comparing a recording signal level and a playback signal level obtained when recording a signal on an optical disk and when playing back a recorded signal from the disk, respectively, in the optical disk recording/playback unit shown in FIG. 1;

FIG. 5 is a circuit diagram explaining another example of a preamplifier applicable to the optical disk recording/playback unit shown in FIG. 1;

FIG. 6 is a graph showing the output signal waveforms of the preamplifier shown in FIG. 5; and

FIG. 7 shows a waveform comparing a recording signal level and a playback signal level obtained when recording a signal on an optical disk and when playing back a recorded signal from the disk, respectively, in the optical disk recording/playback unit shown in FIG. 1 equipped with the preamplifier of FIG. 5.

### DETAILED DESCRIPTION OF THE INVENTION

Hereinafter, the preferred embodiments of the present invention will be explained with reference to the accompanying drawings.

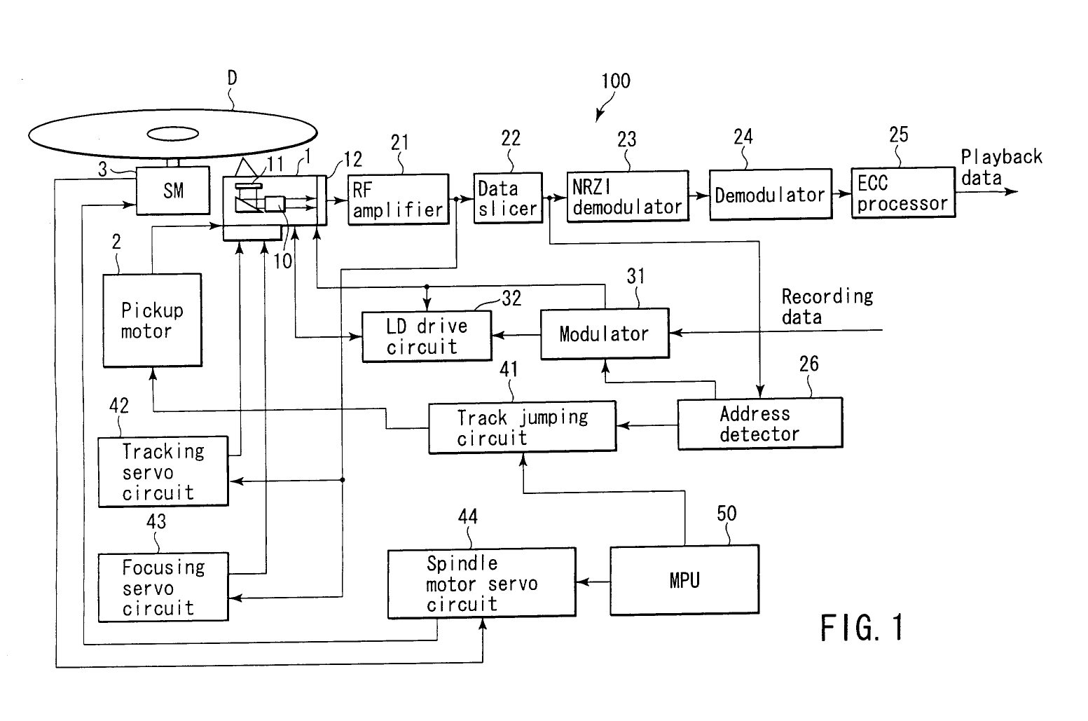

FIG. 1 is a block diagram explaining an example of a recording/playback unit (an optical disk recording/playback unit) to which an embodiment of the present invention is applicable.

An optical disk recording/playback unit 100 records data on an optical disk D as an optical data recording medium, or plays back the prerecorded data from the optical disk D.

An optical disk recording/playback unit 100 includes an optical pickup unit (PU) 1 which emits light of predetermined wavelength (a laser beam) onto an optical disk D, receives the light reflected by the optical disk D, and outputs an electric signal corresponding to the strength of the received light; a pickup motor 2 which moves the PU 1 radially on the optical disk D; a spindle motor 3 which turns the optical disk D at a predetermined speed, and a signal processing block (a group of circuits) to be explained later.

The pickup 1 includes a laser diode (LD) 10, a condenser lens 11, a photodetector 12 and a condenser lens control system (not shown). Provided between the LD 10 and condenser lens 11 is an optical path (light transmission system) which emits the laser beam from the LD 10 to a predetermined track on the recording surface of the optical disk D. Provided between the photodetector 12 and condenser lens 11 are an optical path (a detection system) which guides the laser beam reflected by the optical disk D to the photodetector 12, and a plurality of optical elements to define these optical paths. Some of the optical elements are shared by the light transmission system and the light detection system.

The signal processing block includes a signal playback system 20 which processes the signals output from the photodetector 12 provided at a predetermined position in the PU 1, a signal recording system 30 which records data on the optical disk D by the PU 1, a servo system 40 which controls the position of the pickup motor 2 and the number of revolutions of the spindle motor 3, and a main control unit (MPU) 50.

The signal playback system 20 includes an RF (high-frequency) amplifier 21, a data slicer 22, an NRZ1 (Non-Return-to-Zero-Inverted) demodulator 23, a demodulator 24, an ECC (Error-Check-Code) processor 25, and an address extractor 26.

The signal recording system 30 includes a modulator 31 and a laser drive circuit 32.

The servo system 40 includes a track jump circuit 41, a track servo circuit 42, a focus servo circuit 43, and a spindle motor servo circuit 44.

In the recording/playback unit 100 shown in FIG. 1, a signal from the photodetector 12 of the PU 1 is amplified by the RF (high-frequency) amplifier 21 up to a predetermined level, and applied to the data slicer 22 to be divided into a signal component for playback data and a signal component for servo data.

One output signal from the data slicer 22 is demodulated by the NRZI demodulator 23 and demodulator 24, and applied to the ECC processor 25 where errors are corrected, and the output is stored in a memory (not shown).

The other output signal from the data slicer 22 is supplied to the address extractor 26. The extracted address data is supplied to the track jump circuit 41 for moving the PU 1 to the position facing an object track during data recording or playback, the modulator 31 for modulating the laser beam strength from LD 10 of the PU 1 according to the information to be recorded, and MPU50. The MPU 50 specifies the track to be traced by the PU 1, or the condenser lens 11, and the track jump circuit 41 supplies the pickup motor 2 with a predetermined drive current necessary to change the position of the PU 1. This is the same when the address extractor 26 specifies the track to record information. On the other hand, the MPU 50 instructs the spindle motor servo circuit 44 of the number of revolutions, and the optical disk D is driven radially on the track (not shown) at the speed corresponding to the specified number of revolutions.

Among the signals from the RF (high-frequency) amplifier 21, the signal not supplied to the data slicer 22 and separated for the servo data is applied to the track servo circuit 42 and focus servo circuit 43.

The position of the pickup 1, or the position of the condenser lens 11 is determined by supplying a predetermined control current from the track servo circuit 42 and focus servo circuit 43 to at least one of the focus coil (not shown) for moving the condenser lens 11 orthogonal to the recording surface of the optical disk D and the track coil (not shown) for moving the condenser lens 11 across the track formed already on the optical disk D.

In the above-mentioned optical disk recording/playback unit 100, the photodetector 12 detects the reflected light obtained from a laser beam of predetermined strength emitted from the LD 10 to the optical disk D, and the detected signal is processed as previously defined, and thereby the data prerecorded on the optical disk D is played back.

In more detail, the output signal from the photodetector 12 is processed through the RF amplifier 21, data slider 22, NRZI demodulator 23, demodulator 24 and ECC processor 25.

When recording data, input data is processed through the modulator 31 and laser drive circuit 32.

In more detail, the LD 10 in the PU 1 is driven by the LD drive circuit 32 and emits a recording laser beam whose strength is modulated based on the recording data applied to the demodulator 31, and the information corresponding to the recording data is recorded on a track of the optical disk D.

The optical disk D is placed on a turntable (not shown) fixed to the rotary shaft of the spindle motor 3. The track travel speed of the optical disk is determined by the number of revolutions of the spindle motor 3 set by the spindle motor servo circuit 44.

As above explained, the PU 1 emits the laser beam from the LD 10 to a track on the recording surface of the optical disk D being turned at a predetermined speed, and records or plays back a signal.

In more detail, when playing back the information recorded on the disk D, the laser beam emitted to a track of the disk D is reflected, and the reflected light is taken out through the condenser lens 11, and guided to the photodetector 12 through light receiving optics (not explained in detail). Namely, the laser beam emitted from the LD 10 is guided to the condenser lens 11 through the light transmission system (optical elements) of PU 1. The guided laser beam is condensed by the condenser lens 11, and focused in a predetermined size (condensed spot diameter) at a predetermined position on the track of the optical disk D. The reflected light from the optical disk D is taken in by the condenser lens 11, and applied to the photodetector 12. The reflected light applied to the photodetector 12 is converted into a current corresponding to the strength of the light, and then converted to a voltage by an I/V converter (not shown), and the converted voltage signal is applied to the RF amplifier 21.

When recording or playing back a signal on/from an optical disk D, the position of the condenser lens 11 is controlled, so that the input light beam is focused on the recording surface of the disk and the input laser beam is located as previously determined on the track of the recording surface of the disk. This control is called track servo or focus servo. The track servo circuit 42 and focus servo circuit 43 detect the position of the condenser lens 11 from the signal output of the photodetector 12, or the signal from the RF amplifier 21, and if the detected position is displaced from the predetermined position, the condenser lens 11 is adjusted to the predetermined position by feedback control.

In more detail, the position of the condenser lens 11 is adjusted by the focus servo control, so that the distance from the condenser lens 11 to the recording surface of the optical disk D becomes equal to the focal distance of the condenser lens 11. Therefore, a laser beam given sufficient convergence to ensure a minimum spot diameter at the focal point of the condenser lens 11 is condensed through the condenser lens 11 on the recording surface of optical disk D with a minimum spot diameter. (On-focus) Whereas, a laser beam being condensed with a minimum spot diameter is located at a predetermined position on the track by the track servo control. (On-track)

The playback signal, or the output of the photodetector 12 amplified by the RF amplifier 21 is supplied also to the data slicer 22 to generate digital data.

The data slicer 22 slices the input playback signal at a predetermined timing, and generates a square wave (digital) signal.

The square wave signal output from the data slicer 22 is applied to the NRZI demodulator 23 to be demodulated as a digital signal.

The demodulated digital signal output from the NRZI demodulator 23 is applied to the demodulator 24, where it is converted into data by units of predetermined data record length, and it is further table converted and output as demodulated data. This output of the demodulator 24 is supplied to the ECC processor 25 provided in the later stage.

The ECC processor 25 corrects errors in the input demodulated data in units of ECC blocks, and outputs it to a memory or an external unit (not shown) as playback data.

A part of the square wave generated by the data slicer 22 is supplied to the address extractor 26, and used to detect the address identifying the position, on the optical disk D, of the digital data being played back.

The address data detected by the address extractor 26 is supplied to the track jump circuit 41.

The pickup 1 is moved radially to a predetermined position on the optical disk D by the driving force generated by the pickup motor 2. The travel distance of the pickup 1 is set as the driving force of the pickup motor 2, according to the distance from the current position (the track being traced) to a target track specified by the track jump circuit 41. For instance, when moving the PU 1 to a predetermined position on the recording surface of the optical disk by the command from the MPU 50, the track jump circuit 41 generates a track jump signal corresponding to the difference between the address of a predetermined position and the address of the current playback position detected by the address extractor 26. The pickup motor 2 generates torque, and moves the PU 1 to the predetermined position. This operation is called track jump.

Whereas, the track traveling speed of the optical disk D is determined by the number of revolutions of the spindle motor 3 driven by the servo signal from the spindle motor servo circuit 44, and its variations. The spindle motor servo circuit 44 receives the command from the MPU 50, and generates a spindle motor servo signal. Receiving this signal, the spindle motor 3 rotates at a predetermined speed. The spindle motor servo circuit 44 monitors the speed of the spindle motor 3 based on the counter-electromotive force generated depending on the number of revolutions of the motor 3, and detects the difference between a predetermined motor speed and the current motor speed. Based on the detection result, the spindle motor servo circuit 44 generates a spindle servo signal and holds the speed of the spindle motor 3 at a predetermined number of revolutions. This process is called spindle motor servo processing.

Description will now be given on a case of writing a signal to an optical disk D.

Recording data (assumed to be data of an ECC block with an error added) is applied to the modulator 31, and converted into a predetermined bit length, 8 bits to 16 bits, for example.

The data converted by the modulator 31 is given a frame synchronizing code or the like, and applied to the laser drive circuit 32. The laser drive circuit 32 generates a recording pulse corresponding to the input data, and drives the LD 10 in the PU 1.

On the optical disk D, a header area for dividing physical sectors is previously formed along the recording track; the header area is formed alternately with a writable data area. The address data recorded in this area can be read out even during recording. The address data is detected by the address extractor 26 through the data slicer 22. The address extractor 26 detects the address data from the playback signal, and gives a write-control signal to the modulator 31 and laser drive circuit 32, in the data area for recording data.

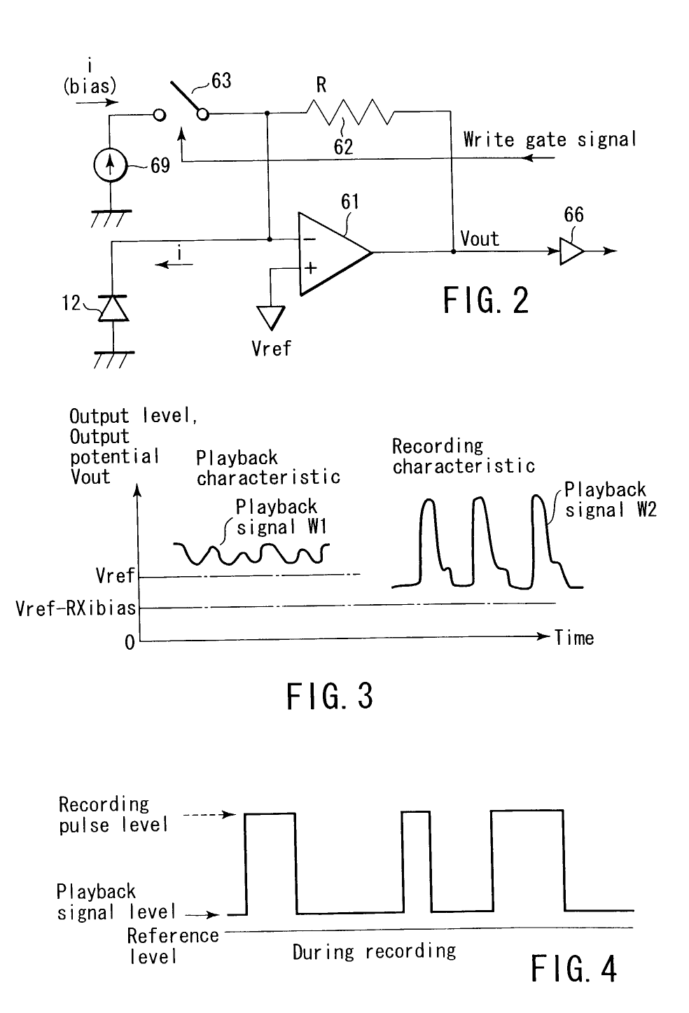

FIG. 2 is a circuit diagram explaining an exemplary preamplifier for processing the output signal from a photodetector incorporated in the pickup shown in FIG. 1.

A photodetector 12 provided at a predetermined position within the pickup 1, as previously described, receives the reflected light, or the laser beam emitted from the LD 10 in the PU 1 and reflected by the recording surface of the optical disk, and outputs a detection signal which is used to generate a playback signal.

The photodetector 12 is a photodiode, for example, and when receiving reflected light, it outputs a current i whose value depends on the strength of the received (emitted) reflected light. One end of the photodetector 12 is grounded, and the other end is connected to the negative (“−”) terminal of an operational amplifier 61.

A reference voltage V_{ref} is applied to the positive (“+”) terminal of the operational amplifier 61. The photodetector 12 is connected between the ground and the negative (“−”) terminal of the operational amplifier 61. The positive and negative terminals of the operational amplifier 61 are connected via a resistor 62. The dynamic range of a playback signal Vₒᵤₜ is determined by the resistance value of the resistor 62. The playback signal Vₒᵤₜ is applied to an RF amplifier 21.

The negative (“−”) terminal of the operational amplifier 61 is connected to a current bias source 69 via a switch 63.

The switch 63 is turned on/off by a write gate signal supplied from the modulator 31 explained before. In detail, the switch 63 is turned on while a recording pulse is being supplied to the LD 10 (while data is being recorded in the data area), and turned off when the address data is read out or when in complete playback mode.

Now, the purpose of turning on/off the switch 63 will be explained in detail.

When a current flows in the photodetector 12, an electric potential is generated depending on the product of the resistance of the resistor 62 by the current flowing in the resistor 62. The difference between this electric potential and the reference voltage is a playback signal Vₒᵤₜ.

While the switch 63 is being turned off, a reference for the input to the operational amplifier 61 is the reference potential V_{ref}. But, when the switch 63 is turned on, the reference for the input to the operational amplifier 61 can be calculated by the formula V_{ref}−R×I (bias), where R is the resistance of the resistor 62, and i (bias) is the bias current supplied by the current bias source 69.

Therefore, the dynamic range of the operational amplifier 61 can be changed by operating the switch 63. The range of changing the dynamic range of the operation amplifier 61 can be freely set by changing the value of i (bias) supplied from the current bias source 69.

FIG. 3 shows the relation between the waveform W1 of the playback signal obtained from the operational amplifier 61 explained above with reference to FIG. 2, the playback signal waveform W2 when detecting the reflected light upon recording, the reference voltage V_{ref}, and V_{ref}−R×i (bias).

By changing the reference voltage V_{ref} to V_{ref}−R×i (bias), the signal-to-noise (S/N) ratio of the playback signal output from the operational amplifier 61 can be ensured at playback.

During recording, the LD 10 is driven with the rated output or close to the rated output in order to securely make a recording mark on the optical disk D. Namely, the LD 10 emits a full-power laser beam. The laser beam strength emitted to the recording surface of the optical disk D will be the maximum obtainable from the LD 10 of the PU 1.

As explained hereinbefore with reference to FIG. 1, the laser beam emitted from the LD 10 of the PU 1 is focused on the recording surface of the optical disk D, and the image forming position is set by the condenser lens 11 to be on-track with respect to the track. That is, a track formed on the optical disk D is certainly traced by the laser beam emitted thereto from the LD 10.

The servo control to trace the track formed by the laser beam emitted from the LD 10 is also necessary when recording a signal on the recording surface of the optical disk D, and it is executed based on the servo signal superposed on the playback signal output from the photodetector 12, as shown in FIG. 2.

However, as the strength of the laser beam emitted to the recording surface of the optical disk D during recording is the maximum obtainable from the LD 10 of the PU 1 as mentioned above, the level of the playback signal generated by reflecting the recording laser beam on the recording surface of the optical disk D becomes several times to several tens of times higher than the level of the playback signal obtained during playback, as shown in FIG. 4.

As a result, the level of the playback signal obtained from the recording laser beam becomes higher than the dynamic range of the operational amplifier 61, and consequently the operational amplifier 61 is saturated. This means that even if the position of the condenser lens 11 is controlled by the playback signal obtained from the recording laser beam, the servo data included in the playback signal is lost, and position control of the condenser lens 11 becomes difficult.

To overcome this difficulty, the optical pickup 1 of the present invention uses a switch 63 shown in FIG. 2 to change the reference potential applied to the operational amplifier 61 at playback and at recording, thereby making it possible to freely set the dynamic range of the operational amplifier 61. That is, if the reference potential of the operational amplifier 61 is set essentially the same at playback and at recording, the playback signal will be distorted when detecting the reflected light obtained from the recording laser beam. By changing the reference potential, the dynamic range of the operational amplifier 61 is expanded, and the level of the playback signal is controlled to be small when detecting the reflected light obtained from the recording laser beam, as shown in FIG. 4.

With the above-mentioned structure, the dynamic range of the operational amplifier 61 is expanded at recording to prevent saturation of the preamplifier, and, thereby, the servo data to control the position of the condenser lens 11, or the position of the laser beam spot on the optical disk D, is prevented from being eliminated from the playback signal.

For the control signal input to the switch 63 (switching control), a switching signal to turn on/off the modulator 31 (FIG. 1) or LD 10 is used.

It is also possible to use a timing signal output from the MPU 50 for the switching control.

Further, it is permissible to connect a dummy amplifier 66 to the output of the operational amplifier 61 in order to stabilize the reference potential. In this case, the connection of the dummy amplifier 66 will stabilize the reference level of the playback signal to be given to the signal processor in the later stage, preventing the circuit from being influenced by the operation of the switch 63.

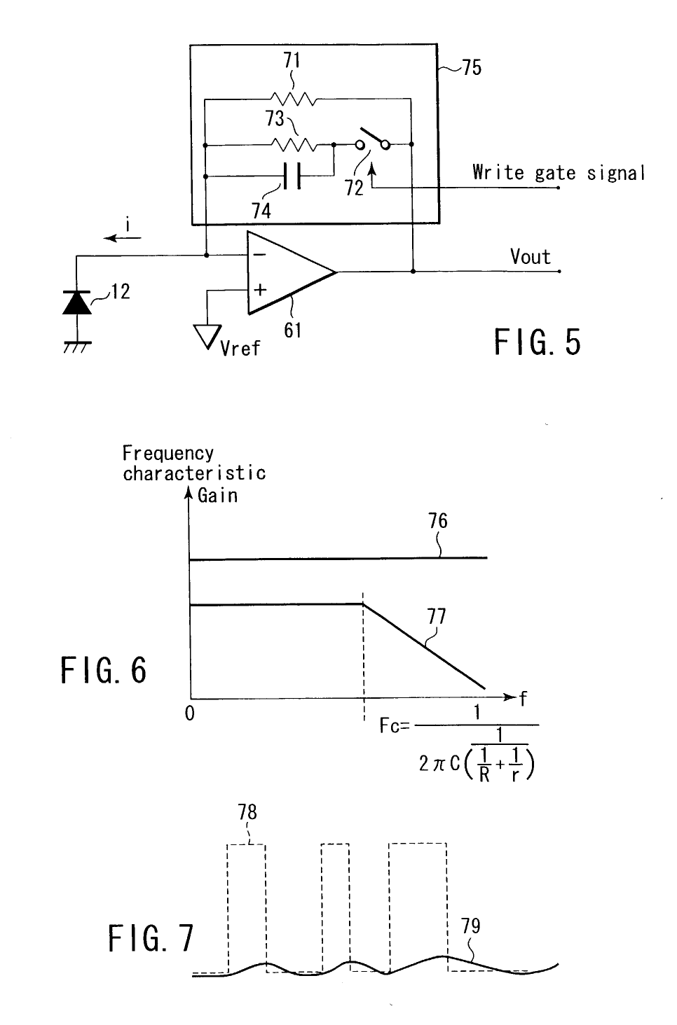

FIG. 5 is a circuit diagram explaining another example of a preamplifier applicable to the optical disk recording/playback unit shown in FIG. 1 In this figure, the same reference numerals are given to the same components as those in FIG. 2, and a detailed description will be omitted.

The photodetector 12 is a photodiode, for example, and when receiving reflected light, it outputs a current i whose value depends on the strength of the received (emitted) reflected light. One end of the photodetector 12 is grounded, and the other end is connected to the negative terminal of an operational amplifier 61.

A reference voltage V_{ref} is applied to the positive terminal of the operational amplifier 61. A photodetector 12 is connected between the ground and the negative terminal of the operational amplifier 61. The positive and negative terminals of the operational amplifier 61 are connected via a resistor 71.

Further, a resistor 73 and a capacitor 74 are connected in parallel. They are connected and disconnected by a switch 72. When the switch 72 is turned on, the resistor 73 and capacitor 74 are connected in parallel to the resistor 71. This parallel connection by the resistor 71, resistor 73 and capacitor 74 forms a low-pass filter 75.

In the channel which includes such a low-pass filter 75 and amplifies the output of the photodetector 12, the dynamic range of the playback signal Vₒᵤₜ is determined by the resistance of the resistor 71. The playback signal Vₒᵤₜ is the difference between the reference voltage V_{ref} and the voltage corresponding to the strength of the incident laser beam from the photodetector 12.

In the above channel for amplifying the output of the photodetector 12, the frequency characteristic and dynamic range of the playback signal Vₒᵤₜ generated at the output terminal of the operational amplifier 61 are changed each time the switch 72 is turned on and off. Turning on/off the switch 72 is equivalent to enabling/disabling filtering of the low-frequency signal (low-frequency component) included in the playback signal.

Therefore, the low-pass filter 75 cuts off the frequency component higher than the cutoff frequency Fc, and passes the lower-frequency component without attenuating the signal level.

As seen from FIG. 6, when the switch 72 is opened, the playback signal shows a certain gain regardless of whether the frequency component is high or low, as indicated by the curve 76. That is, when the switch is opened, the frequency characteristic of the operational amplifier 61 has a dynamic range determined by the resistor 71, and shows a flat gain in all frequency ranges.

Conversely, when the switch 72 is closed, as shown by the curve 77, the playback signal shows a flat gain for the frequency component lower than the cutoff frequency Fc, but attenuates at a predetermined rate for frequencies higher than the cutoff frequency Fc, or 1/[2πC{1/(1/R+1/r)}], where R is the resistance of the resistor 71, r is the resistance of the resistor 73, and C is the capacitance of the capacitor 4.

That is, when the switch 72 turns on, the operational amplifier 61 shows the characteristic of a typical low-pass filter; passing and amplifying the frequency component lower than the cutoff frequency Fc without attenuation, and amplifying the higher frequency component while attenuating at a predetermined rate.

When recording a signal on an optical disk D, the recording surface of the disk must be strongly marked in many cases, and the output of the LD 10 of the optical pickup 1 should be set to maximum. In this case, the laser beam strength emitted to the recording surface of the disk D will be the maximum obtainable from the LD 10.

As a result, as previously explained by referring to FIGS. 3 and 4, the level of the playback signal generated by reflecting the recording laser beam on the recording surface of the optical disk D becomes very high compared to the playback signal level obtained at playback, and reaches several times to several tens of times higher, as shown in FIG. 4.

Conversely, when obtaining a playback signal from the reflected light generated by reflecting the recording laser beam from the recording surface of the optical disk, the low-pass filter shown in FIGS. 5, 6 is used to obtain a playback signal whose low-frequency component is filtered as shown by the curve 79 in FIG. 7. That is, by filtering the low-frequency component of the playback signal, the gain of the playback signal is controlled to have sufficient dynamic range, thereby suppressing the playback signal level. Accordingly, the output of the operational amplifier 61 is not saturated, sufficient dynamic range is ensured, and the servo signal included in the playback signal is not lost. Therefore, the variations (signal components) usable as servo data can be securely extracted from the playback signal, improving the track servo and focus servo accuracy of the condenser lens 11 for condensing the laser beam with a predetermined spot diameter at a predetermined position on the optical disk D.

If the low-pass filter shown in FIGS. 5, 6 is not used, the playback signal is output without being filtered in its low-frequency component, as shown by the curve 78 in FIG. 7. In this case, as previously explained with reference to FIG. 3, the playback signal level obtained from the recording laser beam becomes higher than the dynamic range of the operational amplifier 61, and the operational amplifier 61 is saturated. This means that even if the position of the condenser lens 11 is controlled by the playback signal obtained from the recording laser beam, the servo data included in the playback signal is lost, and position control of the condenser lens 11 becomes difficult.

Further, as shown in FIG. 5, the switch 72 is closed by the write gate signal during recording.

The switch 72 is opened by the write gate signal during playback, and the playback signal gain can be increased without passing the low-frequency component of the playback signal. This will realize a preamplifier which provides satisfactory characteristics for either recording or playback.

As explained heretofore, in the optical pickup and optical disk recording/playback unit of the present invention, when a playback signal for providing a servo signal to control the condenser lens position is obtained from the reflected light produced by reflecting a recording laser beam from an optical disk, the playback signal level is controlled not to saturate the operational amplifier output, and the servo data included in the playback signal is not lost.

Namely, the servo data can be securely extracted from the playback signal, and the servo control accuracy of the condenser lens, which controls the laser beam position on the optical disk, is improved. This will finally enhance the reliability of an optical disk recording/playback unit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical pickup comprising:
a laser output section to emit a laser beam onto a recording medium;
a photodetector to receive reflected light from said recording medium;
an amplifier to output a signal corresponding to the strength of the reflected light output from said photodetector;
a current bias circuit to output a bias current;
a switch circuit which is provided between said current bias circuit and the input terminal of said amplifier, and controls said bias current from said bias circuit; and
a control circuit to control said switch circuit depending on data recording state and data playback state.

2. An optical pickup according to claim 1, wherein said control circuit controls said switch circuit depending on a signal which changes for data recording and the data playback.

3. An optical pickup according to claim 2, wherein said signal changing for data recording and playback is obtained from a modulator which modulates data to be recorded.

4. An optical disk recording/playback unit comprising:
a disk motor to turn a recording medium at a predetermined speed;
a laser output section to emit a laser beam to said recording medium;
a photodetector to receive reflected light from said recording medium;
an amplifier to output a signal corresponding to the strength of the reflected light output from said photodetector;
a current bias circuit to output a bias current;
a switch circuit which is provided between said current bias circuit and the input terminal of said amplifier, and controls said bias current received from said bias circuit; and
a control circuit to control said switch circuit depending on data recording state and data playback state.

5. An optical pickup for use in an optical disk unit capable of recording a signal on an optical disk, and for recording the signal by emitting a light beam to the optical disk, comprising:
a light source to generate the light beam to be emitted to the optical disk;
a photodetector which detects a light beam reflected by the recording surface of the optical disk, and outputs a playback signal containing servo data to generate a servo signal for controlling the light beam position on the recording surface; and
an amplifier which passes a frequency component of the playback signal obtained from said photodetector lower than a predetermined cutoff frequency when recording a signal.

6. An optical pickup according to claim 5, wherein said amplifier includes a low-pass filter.

7. An optical disk recording/playback unit comprising:
an optical pickup including a light source to generate a light beam to be emitted to an optical disk; a photodetector which detects a light beam reflected by the recording surface of the optical disk, and outputs a playback signal containing servo data to generate a servo signal for controlling the light beam position on the recording surface; and an amplifier which passes a frequency component of the playback signal obtained from said photodetector lower than a predetermined cutoff frequency when recording a signal; and
a disk motor to turn a recording medium at a predetermined speed.

8. An optical disk recording/playback unit according to claim 7, wherein said amplifier includes a low-pass filter.
